(19) United States
(12) Patent Application Publication
(10) Pub. No.: US 2008/0025438 A1
(43) Pub. Date: Jan. 31, 2008

(54) METHOD AND APPARATUS FOR DEMODULATING SATURATED DIFFERENTIAL PSK SIGNALS

(75) Inventors: Xiaoming Yu, Cupertino, CA (US); Qin Zhong, Beijing (CN)

Correspondence Address: FELIX L. FISCHER, ATTORNEY AT LAW, 1607 MISSION DRIVE, SUITE 204, SOLVANG, CA, 93463, US

(73) Assignee: UTStarcom, Inc., Alameda, CA (US)

(21) Appl. No.: 11/456,506

(22) Filed: Jul. 28, 2006

(51) Int. Cl. H04L 27/22

(52) U.S. Cl. 375/330

(57) ABSTRACT

Demodulating a DPSK signal is accomplished using a saturated signal, and subjecting the signal to a low pass filter for noise reshaping. Higher order demodulation is then conducted on the reshaped signal. Sporadic constellation pull-away which occurs will result in random demodulation errors which will be correctly interpreted as in more conventional approaches using higher order demodulation.

### REFERENCE TO RELATED APPLICATIONS

This application is a co-pending with U.S. patent application Ser. No. 11/380,885 filed on Apr. 28, 2006 entitled AN ITERATIVE FREQUENCY OFFSET ESTIMATOR FOR PSK MODULATION having a common assignee as the present invention, the disclosure of which is incorporated herein as though fully set forth.

### BACKGROUND OF THE INVENTION

1. Field of the Invention

This invention relates generally to the field of demodulation of phase shift keying signals in radio telephony and, more particularly, to an apparatus and method for employing a saturated DPSK signal using low pass filtering and a high order differential demodulation.

2. Description of the Related Art

Phase shift keying (PSK) modulation and its variations, such as π/4 QPSK and differential PSK, are widely used in wireless communication systems as described by Y. Okunev in Phase and Phase-difference Modulation in Digital Communications, Artech House, 1997. Well known examples are the third generation WCDMA system, which uses QPSK modulation, and the PHS system, which uses π/4 differential QPSK.

In wireless communications, the transmitted electromagnetic waves often do not reach the receiving antenna directly due to obstacles blocking the line-of-sight path. In fact, the received waves are a superposition of waves coming from all directions due to reflection, diffraction, and scattering caused by buildings, trees, and other obstacles. This effect is known as multipath propagation. Depending on the phase of each partial wave, the superposition can be constructive or destructive as described in Matthias Patzold, Mobile Fading Channel, John Wiley & Sons, Ltd, 2002. The multipath phenomenon coupled with the movement of the users, contributes to the large variation of received signal strength in wireless systems. To cope with this large variation, practical wireless receivers have to handle very large dynamic range.

Receivers with large dynamic range are difficult and expensive to build. One way of avoiding expensive receivers is to allow saturation when signal level is high and thus reduce the signal level range a receiver needs to accomodate. This requires effective demodulation methods that are capable of demodulating saturated signals. It is therefore desirable to provide a method that uses inexpensive low pass filtering and a high order differential demodulation scheme to effective demodulate the saturated DPSK signal. It is further desirable to provide a system that applies to DPSK and its variations such as π/4 DQPSK.

### SUMMARY OF THE INVENTION

The present invention provides a method for demodulating a DPSK signal using a saturated signal, receiving the saturated input signal and subjecting the signal to a low pass filter for noise reshaping. Higher order demodulation is then conducted on the reshaped signal with the result that sporadic constellation pull-away will still happen, but the resulting demodulation errors will be random as in more conventional approaches using higher order demodulation.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements of a system employing the present invention;

FIG. 2 is a block diagram of an exemplary embodiment of the invention with digital filtering of the saturated signal;

FIG. 3 is a block diagram of an exemplary embodiment of the invention with analog filtering of the saturated signal prior to digitization for higher order demodulation.

### DETAILED DESCRIPTION OF THE INVENTION

For implementation of the invention each symbol of a received DQPSK signal can be described in baseband complex format by the following equation:

S(k)=Cₖe^{jθ}+n(k) (1)

### Where k represents the samples and k=0,1, . . . K. In this equation perfect frequency synchronization is assumed and θ is the phase offset. n(k) is the white Gaussian noise, Cₖ belongs to the PSK constellation and satisfies

$${C}_{k} = {C}_{k - 1} * {e}^{j \frac{2 π}{4} {a}_{k}} \qquad ( 2 )$$

where aₖ is the modulated data symbol, and 0≦αₖ≦3

For higher order demodulation, the demodulation process can be described as

$$S ( k ) * {S}^{*} ( k - 1 ) = {e}^{j \frac{2 π}{4} {a}_{k}} + {n}^{′} ( k ) \qquad ( 3 )$$

n′(k) is the noise term resulting from signal multiplied by noise and noise multiplied by noise. The demodulation of differential QPSK signal is based on the following equation

$${V}_{k} = \frac{2}{π} arg \{ S ( k ) * {S}^{*} ( k - 1 ) \} \qquad ( 4 )$$

In an exemplary embodiment employing gray coding which is commonly used in communication systems, the decision rules are:

$${a}_{k} = \{ \begin{matrix}3 \\ 0 \\ 1 \\ 2\end{matrix} if \begin{matrix}0 < {V}_{k} \leq π / 2 \\ π / 2 < {V}_{k} \leq π \\ π < {V}_{k} \leq 3 π / 2 \\ 3 π / 2 < {V}_{k} \leq 2 π\end{matrix} \qquad ( 5 )$$

This demodulation scheme can be improved using high order differential demodulation as described by H. Schroeder and J. Sheehan in U.S. Pat. No. 3,529,290 entitled Non-redundant Error Detection and Correction System issued September 1970 and by D. Wong and P. Mathiopoulos in their article Non-redundant Error Correction Analysis and Evaluation of Differentially Detected π/4-shift DQPSK Systems in a Combined CCI and AWGN Environment, IEEE Trans on Vehicular Technology, Vol. 41, No 1, February 1992.

In a differential demodulated system, the signals, namely, S(k), S(k−1), . . . , S(k-L) are not independent. Similar to Equation (3), we have

$$S ( k ) * {S}^{*} ( k - m ) = {e}^{j \frac{2 π}{4} {\sum }_{i = k - m + 1}^{k} {a}_{i}} + {n}^{′} ( k ) \qquad ( 6 )$$

n′(k) is the noise term resulting from signal multiplied by noise and noise multiplied by noise. Similar to Equation (4)

$$\begin{matrix}{V}_{k}^{m} = \frac{2}{π} arg \{ S ( k ) * {S}^{*} ( k - m ) \} \\ and & ( 7 ) \\ mod ( {\sum }_{i = k - m - 1}^{k} {a}_{i} , 4 ) = \{ \begin{matrix}3 \\ 0 \\ 1 \\ 2\end{matrix} if \begin{matrix}0 < {V}_{k}^{m} \leq π / 2 \\ π / 2 < {V}_{k}^{m} \leq π \\ π < {V}_{k}^{m} \leq 3 π / 2 \\ 3 π / 2 < {V}_{k}^{m} \leq 2 π\end{matrix} & ( 8 )\end{matrix}$$

Simplifying variables to denote

$${X}_{k}^{m} = mod ( {\sum }_{i = k - m + 1}^{k} {a}_{i} , 4 ) ,$$

then

αₖ=Xₖ^{m}−Xₖ^{m-1}=Xₖ^{m-1}−Xₖ^{m-2}= . . . (9)

Equation (9) can be used to provide multiple solutions for aₖ. One way of making use of these multiple solutions is to choose the solution based on the majority coming out of Equation (9). An example of this decision rule is given below.

Assuming variables Xₖ^{m}, Xₖ^{m-1}, Xₖ^{m-2}, Xₖ^{m-3}, Xₖ^{m-4}, Xₖ^{m-5}, using Eqn [9], five decisions about the same αₖ. are obtained, which are 3,0,0,1,0. The solution having the highest mode (number of appearances), which is 0, is selected and assigned to the decoder output. When there is a tie, such as 3,0,1,1,0, a random selection of one value among the tied values is made as the decoder output; in the exemplary case, it can be either 1 or 0.

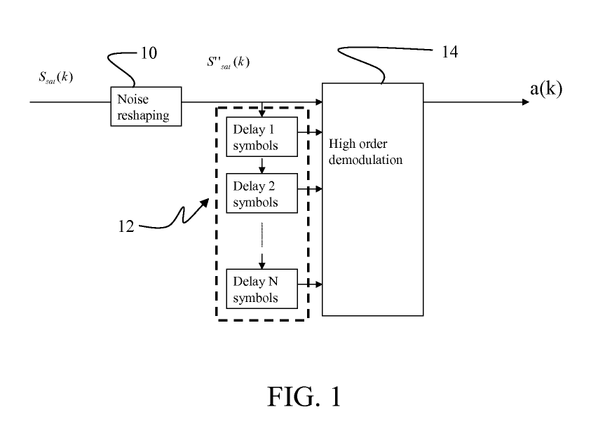

FIG. 1 shows a block diagram of the elements of the invention. A low-pass noise reshaping filter 10 followed by a high order differential demodulation scheme which employs delay line elements 12 and a higher order demodulator element 14

Higher order demodulation schemes have been employed in the prior art to improve performance under low SNR or to improve the ability of the demodulator to counter low level interference as shown in the IEEE article of D. Wong and P. Mathiopoulos, Non-redundant Error Correction Analysis and Evaluation of Differentially Detected π/4-shift DQPSK Systems in a Combined CCI and A WGN Environment.

One thing common to both these cases is that the errors are sporadic. In the present invention, the high order demodulation scheme, is used to improve the performance of highly saturated DQPSK signal. The present invention therefore provides elements to pre-process the saturated DQPSK signal first.

Sₛₐₜ(k), the saturated DQPSK signal, can be viewed as S(k) the original signal superimposed by a noise signal Nₛₐₜ(k), i.e.,

Sₛₐₜ(k)=S(k)+Nₛₐₜ(k) (10)

The power of Nₛₐₜ(k) is proportional to the level of saturation. The more saturation a signal experiences, the higher its power. The impact of Nₛₐₜ(k) is that it pulls S(k) away from its original constellation and thus results in possible error detection. For highly saturated DQPSK signals, this error detection happens quite often.

The spectrum of Nₛₐₜ(k) contains many high frequency components compared with S(k). An ideal low pass filter, which has a pass band that exactly matches the signal bandwidth will filter out all the out of band noise and thus improve the signal-to-noise ratio for detection. An ideal low pass filter, is of course not realizable consequently filters that approximate the response of the ideal low pass filter are employed. In many communication systems where there are pulse shaping filters such as raised-cosine filters, the existing pulse shaping filter is sufficient for this purpose.

After the reshaping of noise, the new saturated signal, which is denoted as S′ₛₐₜ(k), more closely represents S(k). Sporadic constellation pull-away will still happen, but the resulting demodulation errors will be random. This provides a very good signal source on which higher order demodulation can be used.

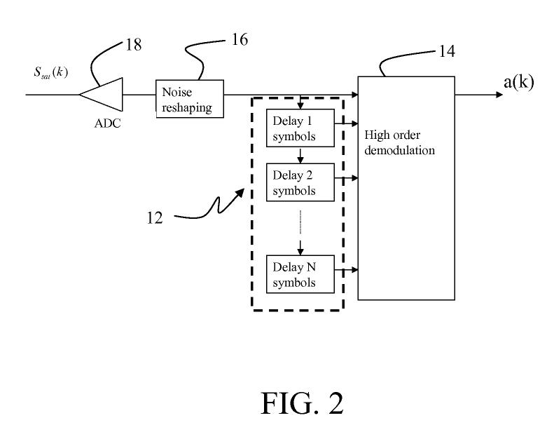

FIG. 2 demonstrates an embodiment of the invention in which the noise shaping is implemented digitally The high order differential demodulation is carried out digitally in the embodiments of the invention disclosed herein, while the low pass filter can be implemented in either analog domain or digital domain. FIG. 2 shows the noise shaping filter 16 implemented digitally. In this case, an analog-to-digital converter (ADC) 18 is used to sample the saturated signal first to provide Sₛₐₜ(k) to the filter. The output of the filter is provided to the delay line elements 12 for processing by the higher order demodulator 14.

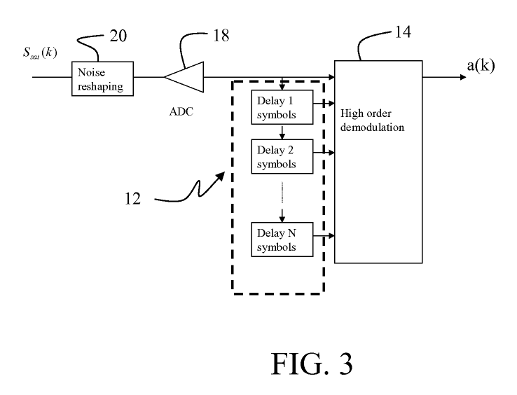

FIG. 3 shows an embodiment of the invention in which the noise shaping is implemented in analog domain. Low pass filter 20 receives signal S(k) and provides the resulting filtered output to the ADC 18. In this embodiment, the noise shaping also functions as an anti-aliasing filter for the ADC. The ADC provides the digitized output for S′ₛₐₜ(k) to the delay line elements 12 for processing by the higher order demodulator 14.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A system for demodulation of DPSK signals comprising;
means for noise reshaping receiving a saturated DPSK signal and providing a low pass output;
a higher order demodulator receiving the low pass output and providing an output with multiple solutions for further processing.

2. A system as defined in claim 1 in which the noise reshaping means comprises a pulse shaping filter.

3. A system as defined in claim 1 wherein the noise reshaping means is digital and further comprising an analog to digital converter providing the saturated DPSK signal.

4. A system as defined in claim 3 wherein the noise reshaping means is an optimized filter approximating an ideal low pass filter for noise shaping effects.

5. A system as defined in claim 1 wherein the noise reshaping means is analog and further comprises an analog to digital converter intermediate the output of the noise reshaping mains and the higher order demodulator.

6. A system as defined in claim 5 wherein the noise reshaping means also acts as an anti-aliasing filter for the analog to digital converter.

7. A method for demodulating a DPSK signal comprising the steps of:
receiving a saturated input signal;
subjecting the saturated signal to a low pass filter for noise reshaping;
conducting higher order demodulation on the reshaped signal.

8. A method as defined in claim 7 wherein the step of receiving the saturated input signal further includes the step of converting an analog saturated input signal to digital form.

9. A method as defined in claim 7 wherein the step of subjecting the saturated input signal to a low pass filter is followed by the step of converting the output of the low pass filter to a digital signal.

10. A method as defined in claim 8 further comprising the initial step of approximating an ideal low pass filter for noise shaping effects.
